(19) United States
(12) Patent Application Publication
(10) Pub. No.: US 2012/0189944 A1
(43) Pub. Date: Jul. 26, 2012

(54) SOLID ELECTROLYTE FOR SOLID OXIDE FUEL CELL, AND SOLID OXIDE FUEL CELL INCLUDING THE SOLID ELECTROLYTE

(75) Inventors: Hee-jung PARK, Suwon-si (KR); Kyoung-seok MOON, Hwaseong-si (KR); Kyong-bok MIN, Suwon-si (KR)

(73) Assignees: SAMSUNG ELECTRO-MECHANICS CO., LTD., Suwon-si (KR); SAMSUNG ELECTRONICS CO., LTD., Suwon-si (KR)

(21) Appl. No.: 13/355,961

(22) Filed: Jan. 23, 2012

(30) Foreign Application Priority Data
Jan. 24, 2011 (KR) 10-2011-0006837

(51) Int. Cl. H01M 8/12

(52) U.S. Cl. 429/495

(57) ABSTRACT

A solid electrolyte for a solid oxide fuel cell, the solid electrolyte including: a zirconia layer; and a hybrid layer including a hybrid phase according to Formula 1:

(1−y)(Ce₁₋ₓL′O₂)+y(L″MO₃) Formula 1

wherein the hybrid layer is disposed on at least one surface of the zirconia layer, and wherein, L′ and L″ are each independently at least one element selected from the lanthanide group, M is at least one element selected from aluminum, gallium, Indium, and scandium, x is about 0.0001 to about 0.3, and y is about 0.0003 to about 0.05.

### CROSS-REFERENCE TO RELATED APPLICATIONS

This application claims priority to Korean Patent Application No. 10-2011-0006837, filed on Jan. 24, 2011, and all the benefits accruing therefrom under 35 U.S.C. §119, the content of which in its entirety is herein incorporated by reference.

### BACKGROUND

1. Field

The present disclosure relates to a solid electrolyte for a solid oxide fuel cell, and a solid oxide fuel cell including the solid electrolyte.

2. Description of the Related Art

A solid oxide fuel cell (“SOFC”) is a highly efficient and eco-friendly electrochemical power-generating unit that directly converts chemical energy of a fuel gas into electric energy.

The SOFC has many advantages over other types of fuel cells. For example, it may use a relatively inexpensive fuel because it can have a relatively high tolerance to fuel impurities. Also, the SOFC can provide hybrid power generation capability, and high efficiency. Furthermore, the SOFC may directly use a hydrocarbon-based fuel without having to reform the fuel into hydrogen, which makes an SOFC fuel cell system simpler and thus can reduce the overall cost of the system.

Generally, the SOFC includes an anode where a fuel, such as hydrogen or hydrocarbon, is oxidized, a cathode where oxygen gas is reduced to oxygen ions (O²⁻), and a solid electrolyte which conducts the oxygen ions (O²⁻).

Commercially available SOFCs use an alloy or an expensive ceramic material that is stable at high temperatures because such SOFCs operate at a high temperature, e.g., about 800 to about 1000° C. Such SOFCs can have a long initial system start-up time, and can suffer from materials degradation or other materials durability issues after extended operation. Among these and other challenges, the overall cost is a significant barrier to successful commercialization of SOFCs.

Therefore, there remains a need to lower the operating temperature of the SOFC to 800° C. or less. However, the lowering of the operating temperature of the SOFC causes a dramatic increase in the electrical resistance in a cathode material for the SOFC, which in turn decreases the output power of the SOFC. Thus it would be desirable to reduce the cathode resistance to allow use of a lower operating temperature of the SOFC.

### SUMMARY

Provided is a solid electrolyte for solid oxide fuel cells including a high-density ceria hybrid phase that substantially or effectively prevents undesirable diffusion of a cathode material.

Also provided is a solid oxide fuel cell including the solid electrolyte.

Additional aspects will be set forth in part in the description which follows and, in part, will be apparent from the description.

According to an aspect, a solid electrolyte for a solid oxide fuel cell includes a zirconia layer; and a hybrid layer including a hybrid phase according to Formula 1:

(1−y)(Ce₁₋ₓL′O₂)+y(L″MO₃), Formula 1

wherein the hybrid layer is disposed on at least one surface of the zirconia layer, and wherein L′ and L″ are each independently at least one element selected from the lanthanide group, M is at least one element selected from aluminum (Al), gallium (Ga), Indium (In), and scandium (Sc), x is about 0.0001 to about 0.3, and y is about 0.0003 to about 0.05.

A relative density of the hybrid coating layer may be about 80%.

The relative density of the hybrid coating layer may be about 80% to about 98%.

The hybrid coating layer may comprise a reaction preventing layer.

The at least one element selected from the lanthanide group may be at least one selected from gadolinium (Gd) and samarium (Sm).

M may include aluminum (Al).

The zirconia layer may include at least one selected from yttria-stabilized zirconia (YSZ) and scandia-stabilized zirconia (ScSZ).

The hybrid coating layer may have a thickness of about 1 micrometer to about 30 micrometers.

According to another aspect, disclosed is a hybrid phase is according to Formula 1:

(1−y)(Ce₁₋ₓL′O₂)+y(L″MO₃), Formula 1

wherein, L′ and L″ are each independently at least one element selected from the lanthanide group, M is at least one element selected from among aluminum (Al), gallium (Ga), Indium (In), and scandium (Sc), x is about 0.0001 to about 0.3, and y is about 0.0003 to about 0.05.

According to another aspect, disclosed is a solid oxide fuel cell including a cathode; an anode; and the solid electrolyte as disclosed above interposed between the cathode and the anode.

The solid oxide fuel cell may further include a second hybrid coating layer interposed between the solid electrolyte and the cathode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view of an embodiment of a half-cell including an embodiment of a solid electrolyte;

FIG. 2 is a conceptual view of a triple phase boundary that is present in the half-cell of FIG. 1;

FIG. 3 is a cross-sectional view of an embodiment of a half-cell including another embodiment of the solid electrolyte;

FIG. 4 is a graph of relative density (percent, %) versus content of GdAIO₂ or SmAlO₂ (weight percent, wt %) which shows relative densities of solid electrolytes prepared according to Comparative Example 1, Examples 1 to 3, Comparative Example 2 and Examples 4 to 6;

FIG. 5 is a scanning electron micrograph (“SEM”) of the electrolyte obtained from Comparative Example 1;

FIG. 6 is an SEM of the solid electrolyte obtained from Example 1;

FIG. 7 is an SEM of the solid electrolyte obtained from Example 2;

FIG. 8 is an SEM of the solid electrolyte obtained from Example 3;

FIG. 9 is a graph of intensity (arbitrary units, a.u.) versus scattering angle (degrees two-theta, 20), which shows X-ray diffraction (“XRD”) results according to added amount of GdAIO3;

FIG. 10 is an SEM of the solid electrolyte obtained from Comparative Example 2;

FIG. 11 is an SEM of the solid electrolyte obtained from Example 4;

FIG. 12 is an SEM of the solid electrolyte obtained from Example 5;

FIG. 13 is an SEM of the solid electrolyte obtained from Example 6;

FIG. 14 is a graph of intensity (arbitrary units, a.u.) versus scattering angle (degrees two-theta, 2θ), which shows XRD results according to an added amount of SmAlO₃;

FIG. 15 is an SEM which shows a microstructure of a hybrid layer obtained from Example 3; and

FIG. 16 is an SEM, which shows a microstructure of a coating layer obtained from Comparative Example 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

An embodiment of a solid electrolyte for a fuel cell includes a zirconia layer, and a hybrid layer disposed on (e.g., formed on) at least one side of the zirconia layer, wherein the hybrid layer comprises a hybrid phase represented by Formula 1:

(1−y)(Ce₁₋ₓL′O₂)+y(L″MO₃) Formula 1

wherein, L′ and L″ are each independently at least one element selected from the lanthanide group,

M is at least one element selected from among aluminum (Al), gallium (Ga), Indium (In), and scandium (Sc),

x is about 0.0001 to about 0.3, and

y is about 0.0003 to about 0.05.

The hybrid layer, which comprises the hybrid phase represented by Formula 1, is disposed (e.g., formed) on at least one surface of the zirconia layer. The hybrid layer may have a high relative density.

Generally, when the zirconia layer is employed as an electrolyte in a fuel cell, a nonconductor may be formed in the fuel cell due to a reaction between a cathode and an electrolyte, which brings about a drastic increase in resistance. The increase in resistance may be substantially or effectively prevented by interposing a functional layer, e.g., a reaction preventing layer, between the cathode and the zirconia layer to suppress or effectively eliminate the formation of the nonconductor. For example, a high-density reaction preventing layer may be disposed (e.g., formed) to suppress or effectively eliminate the increase in resistance. Alternatively, if a low-density reaction preventing layer is employed, the low-density reaction preventing layer would not likely completely prevent the diffusion of the cathode material, thus may permit formation of the nonconductor.

Since the hybrid layer represented by Formula 1 is positioned between the cathode and the electrolyte, a reaction between the cathode and the electrolyte is suppressed. Also, since the hybrid layer represented by Formula 1 has a high-density structure, the reaction preventing effect may be further enhanced.

The hybrid layer may have a relative density of about 50% to about 99.5%, specifically about 60% to about 99%, more specifically about 70% to about 98%, or about 80% or more, wherein the relative density is a relative value with respect to a theoretical density of 100%, i.e., a material having no pores. If the relative density of the hybrid layer is within the foregoing range, a reaction between the cathode and the electrolyte may be sufficiently or effectively suppressed, and thus, the formation of the nonconductor may be effectively or sufficiently suppressed, and therefore an increase in resistance may also be effectively prevented.

A relative density of the hybrid layer of about 80% or more, e.g., about 80% to about 99%, is specifically mentioned, but it is not limited thereto, and any relative density is acceptable if it sufficiently suppresses the reaction between the cathode and electrolyte layers.

A material used for forming the hybrid layer is a hybrid phase of a ceria-based metal oxide and a lanthanide metal oxide. The term “hybrid phase” as used herein refers to a composition manufactured from two or more materials that have physically or chemically different properties and are separated and distinguished from each other in a finished structure at the macroscopic or microscopic scale.

The ceria-based metal oxide, one of the constituents of the hybrid phase, has a composition of Ce₁₋ₓL′O₂, in which L′ refers to at least one element selected from the lanthanide elements, wherein the lanthanide elements are the 15 elements from lanthanum (La), which has an atomic number of 57, to lutetium (Lu), which has an atomic number of 71. In an embodiment, L′ may be Gd or Sm. In an embodiment, x is about 0.0001 to about 0.3, specifically about 0.001 to about 0.25, more specifically about 0.05 to about 0.2.

A lanthanide metal oxide, the other constituent of the hybrid phase, may be, for example, a material having a perovskite crystal structure. An example thereof is a material having a composition of L″MO₃, where L″ refers to at least one element selected from the lanthanide elements. In an embodiment, L′ may be Gd or Sm. In an embodiment M may be at least one element selected from Al, Ga, In, and Sc. An embodiment wherein M is Al is specifically mentioned.

The two constituents of the hybrid phase, i.e., the ceria-based metal oxide and the lanthanide metal oxide, may be used in a selected ratio. For example, the ceria-based metal oxide may be contained in an amount of about 95 weight percent (wt %) to about 99.97 wt %, specifically about 95 wt % to about 99.97 wt %, more specifically about 98 wt % to about 99.9 wt %, based on the total weight of the hybrid phase, and the lanthanide metal oxide may be contained in an amount of about 0.03 wt % to about 5 wt %, specifically about 0.5 wt % to about 4 wt %, more specifically about 0.1 wt % to 2 wt %, based on the total weight of the hybrid phase. Within the foregoing range, a hybrid layer, which is a high-density reaction preventing layer, may be formed.

The ceria-based metal oxide and the lanthanide metal oxide may be manufactured using a predetermined method, such as, for example, a solid state reaction method. In an embodiment, a commercially available ceria-based metal oxide may be used as the ceria-based metal oxide. The hybrid layer may be formed by manufacturing a slurry from a mixture of the ceria-based metal oxide and the lanthanide metal oxide, and optionally an organic vehicle, coating the slurry on a surface of the solid electrolyte, and sintering the slurry on a surface (e.g., side) of the solid electrolyte at a predetermined temperature for a predetermined time.

The organic vehicle may be used to provide desirable properties to the slurry, e.g., properties suitable for screen printing or dipping. Representative organic vehicles include a resin and a solvent. The resin may be a bonding agent and may provide desirable film-forming properties to the slurry, and the solvent may provide a desirable viscosity and/or printability to the slurry. The resin may include at least one selected from polyvinyl alcohol (“PVA”), polyvinylpyrrolidone (“PVP”), and cellulose. The solvent may include at least one selected from ethylene glycol and alpha-terpineol.

The slurry of the mixture of the ceria-based metal oxide and the lanthanide metal oxide may be sintered at a temperature of about 1,200° C. to about 1,600° C., specifically about 1,250° C. to about 1,550° C., more specifically about 1,300° C. to about 1,500° C., for about 1 hours to about 20 hours, specifically about 2 hours to about 18 hours, more specifically about 3 hours to about 16 hours, for example. The sintering process may provide the hybrid layer, which may be formed to have a high-density structure, e.g., a structure having a relative density of about 50% to about 99.5%, specifically about 60% to about 99%, more specifically about 70% to about 98%, or about 80% or more.

A commercially available zirconia may be used for the solid electrolyte, which may be used as a substrate when the hybrid layer is formed, as long as the commercially available zirconia has properties suitable for use in a solid oxide fuel cell. For example, yttria-stabilized zirconia (“YSZ”), which is Y-doped ZrO₂, or scandia-stabilized zirconia (“ScSZ”), which is Sc-doped ZrO₂, may be used. The zirconia layer may be manufactured using a known method, such as a solid state reaction method, and the composition of the zirconia layer is not limited, so long as the zirconia layer has properties suitable for use in a solid oxide fuel cell.

The hybrid layer may be formed on at least one surface of the solid electrolyte in a predetermined thickness, for example, a thickness of about 1 micrometer (μm) to about 30 μm, specifically about 2 μm to about 30 μm, more specifically about 5 μm to about 10 μm. Within the foregoing thickness range, the hybrid layer may provide a sufficient reaction preventing effect without degrading the fuel cell's efficiency.

A cathode for the solid oxide fuel cell, and the solid oxide fuel cell including the cathode will now be explained in detail with reference to the accompanying drawings.

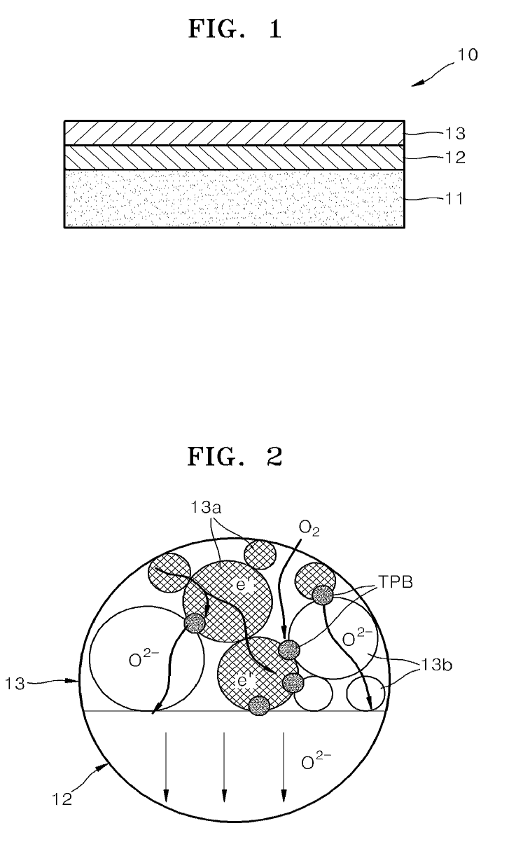

FIG. 1 is a cross-sectional view of an embodiment of a half-cell 10 including an embodiment of a hybrid layer 12, and FIG. 2 is a conceptual view of a triple phase boundary (“TPB”) emerging in connection with FIG. 1.

The half-cell 10 includes an electrolyte layer 11, the hybrid layer 12, and a cathode layer 13.

The electrolyte layer 11 may include a commercially available zirconia. In an embodiment, the electrolyte layer 11 may be at least one selected from ScSZ and YSZ.

While not wanting to be bound by theory, the hybrid layer 12 is understood to substantially or effectively suppress a reaction between the electrolyte layer 11 and the cathode layer 13, and thus substantially prevents or effectively suppresses the formation of a nonconductor, which may result in a nonconductive layer (not shown). The hybrid layer 12 may comprise a hybrid phase according to Formula 1:

(1−y)(Ce₁₋ₓL′O₂)+y(L″MO₃) Formula 1

wherein, L′ and L″ are each independently at least one element selected from the lanthanide group,

M is at least one element selected from Al, Ga, In, and Sc,

x is about 0.0001 to about 0.3, and

y is about 0.0003 to about 0.05.

The cathode layer 13 comprises a cathode material, and for example may comprise a metal oxide having the perovskite type crystal structure, which may be used for the cathode material. The metal oxide particles may comprise at least one selected from (Sm,Sr)CoO₃, (La,Sr)MnO₃, (La,Sr)CoO₃, (La,Sr)(Fe,Co)O₃, and (La,Sr)(Fe,Co,Ni)O₃. The metal oxide may be in the form of particles. In another embodiment, a noble metal, such as, platinum (Pt), ruthenium (Ru), or palladium (Pd), or alternatively a Sr, Co, or Fe-doped lanthanum manganite, such as, La_{0.8}Sr_{0.2}MnO₃ (“LSM”), or La_{0.6}Sr_{0.4}Co_{0.2}Fe_{0.8}O₃ (“LSCF”) may also be used to form the cathode layer 13.

A solid oxide fuel cell (not shown) having the half-cell 10 and further including an anode (not shown) has a large TPB, as shown in FIG. 2, in the cathode layer 13. While not wanting to be bound by theory, it is understood that because of the large TPB, the solid oxide fuel cell is able to maintain a low cathode resistance, even when operated at 800° C. or less (e.g., 600° C.). In other words, at the TPB, a reduction of oxygen (½O₂+2e⁻→>O²⁻) occurs, and the larger the TPB is, the greater the rate of the oxygen reduction reaction. Further, if the reduction of oxygen occurs at a greater rate, then the amount of oxygen ions (O²⁻) increases, thus decreasing the cathode resistance.

Referring to FIG. 2, the TPB refers to an area where an electron conductor 13a, an ion conductor 13b, and oxygen contact each other. At the TPB, the reduction of oxygen occurs using electrons (e⁻) provided from the anode, and the oxygen ions O²⁻ generated from the reduction of oxygen are delivered to the anode through the electrolyte layer 11.

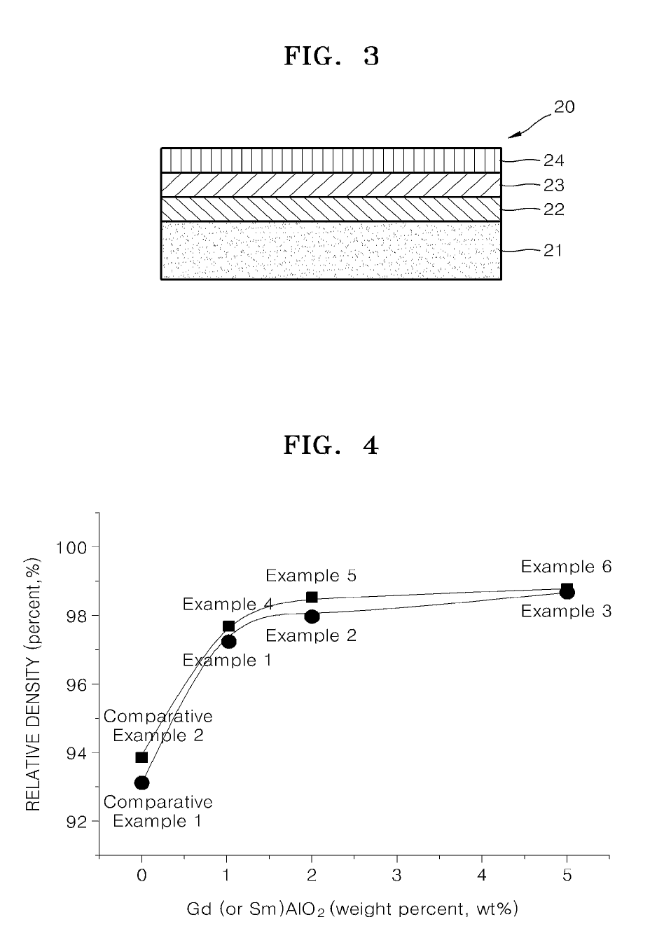

FIG. 3 is a cross-sectional view of a half-cell 20 including a cathode layer 23 according to another embodiment of the present invention.

The half-cell 20 includes an electrolyte layer 21, a hybrid layer 22, a cathode layer 23, and an additional layer 24. The cathode layer 23 and the additional layer 24 together form a cathode. However, the present disclosure is not limited to this example, and many different half-cells and solid oxide fuel cells having a variety of structures or configurations and a different number of layers may also be provided.

The structure and operation of the electrolyte layer 21, the hybrid layer 22, and the cathode layer 23 may be the same as the foregoing electrolyte layer 11, the coating layer of the hybrid compound 12, and the cathode layer 13, respectively.

The additional layer 24 may include a lanthanide metal oxide having a Perovskite crystal structure. The lanthanide metal oxide included in the additional layer 24 may be identical to the lanthanide metal oxide included in the cathode layer 23.

An anode material is not particularly limited and a cermet from a mixture of a metal-doped oxide and a nickel oxide may be used as the anode material. The metal doped oxide may comprise, for example, a zirconia or a ceria and may include at least one metal selected from Yttrium (Y), Scandium (Sc), Ytterbium (Yb), Gadolinium (Gd), Samarium (Sm), Indium (In), Lutetium (Lu), Dysprosium (Dy), Lanthanum (La), Bismuth (Bi), Praseodymium (Pr), Actinium (Ac), Aluminum (Al), Gallium (Ga), and Boron (B) as a dopant. The anode material may additionally include activated carbon. The metal-doped oxide may be in the form of particles.

The solid oxide fuel cell may be a single cell or a stack of cells. For example, the stack of cells may be manufactured by combining the single cells so that they are connected in series, each cell consisting of a cathode, an anode, and solid oxide electrolyte (e.g., membrane and electrode assembly (MEA)), optionally with separators disposed between the cells to electrically connect the individual cells.

The solid oxide fuel cell may be manufactured using an electrolyte support method or an anode support method. According to an embodiment, a solid oxide fuel cell may be manufactured by manufacturing a solid oxide electrolyte in the form of a pellet having a thickness of about 1 μm to about 1000 μm, specifically about 10 μm to about 500 μm, more specifically about 100 μm, forming a hybrid layer and a cathode layer on a first side of the solid oxide electrolyte, the hybrid layer having a thickness of about 1 μm to about 30 μm, specifically about 2 μm to 28 μm, more specifically about 4 μm to 26 μm, and the cathode layer having a thickness of about 1 μm to about 30 μm, specifically about 2 μm to 28 μm, more specifically about 4 μm to 26 μm, coating a predetermined anode material on a second opposite side of the solid oxide electrolyte, and heating the resulting structure.

According to another embodiment, a solid oxide fuel cell may be manufactured by forming a solid oxide electrolyte on an anode by coating a solid oxide electrolyte material on a surface of the anode, the solid oxide electrolyte material having a thickness of about 1 μm to about 50 μm, specifically about 5 μm to about 30 μm, more specifically about 7 μm to 28 μm, forming a hybrid layer thereon, the hybrid layer having a thickness of about 1 μm to about 30 μm thickness, specifically about 2 μm to 28 μm, more specifically about 4 μm to 26 μm, sintering the foregoing, and coating and sintering a cathode material on a side of the solid oxide electrolyte opposite the anode.

An embodiment will now be disclosed in further detail with reference to the following examples. These examples are for illustration purposes only and shall not limit the scope of the disclosed embodiments.

### Preparation Example

The ceria-based metal oxides Gd-doped CeO₂ (“GDC”) and Sm-doped CeO₂ (“SDC”), and the lanthanide metal oxides GdAIO₃ and SmAlO₃, were each manufactured into powdery products by a solid state reaction method.

### Comparative Example 1

The ceria-based metal oxide, GDC, obtained in the Preparation Example, was formed into a pellet shape having the dimensions 10 millimeters (mm) in diameter and 5 mm in thickness using a stainless steel die, and then was sintered at 1550° C. in air.

### Example 1

The ceria-based metal oxide, GDC, and a lanthanide metal oxide, GdAIO₃, obtained in Preparation Example as powdery products, were mixed in a weight ratio of about 99:1. The mixed powder was then formed into a pellet shape having the dimensions 10 mm in diameter and 5 mm in thickness using a stainless steel die, and then was sintered at 1550° C. in air.

### Example 2

The ceria-based metal oxide, GDC, and the lanthanide metal oxide, GdAIO₃, obtained in Preparation Example were mixed in a weight ratio of about 98:2. The mixed powder was then formed into a pellet shape having the dimensions 10 mm in diameter and 5 mm in thickness using a stainless steel die, and then was sintered at 1550° C. in air for about 5 hours.

### Example 3

The ceria-based metal oxide, GDC, and the lanthanide metal oxide, GdAIO₃, obtained in the Preparation Example were mixed in a weight ratio of about 95:5. The mixed powder was then formed into a pellet shape having the dimensions 10 mm in diameter and 5 mm in thickness using a stainless steel die, and then was sintered at 1550° C. in air for 5 hours.

### Comparative Example 2

Another ceria-based metal oxide, SDC, obtained in the Preparation Example was formed into a pellet shape having the dimensions 10 mm in diameter, and 5 mm in thickness using a stainless steel die, and then was sintered at 1550° C. in air for 5 hours.

### Example 4

The ceria-based metal oxide, SDC, and another lanthanide metal oxide, SmAIO₃, obtained in the Preparation Example were mixed in a weight ratio of about 99:1. The mixed powder was then formed into a pellet shape having the dimensions 10 mm in diameter and 5 mm in thickness using a stainless steel die, and then was sintered at 1550° C. in air for 5 hours.

### Example 5

The ceria-based metal oxide, SDC, and the lanthanide metal oxide, SmAIO₃, obtained in the Preparation Example were mixed in a weight ratio of about 98:2. The mixed powder was then formed into a pellet shape having the dimensions 10 mm in diameter and 5 mm in thickness using a stainless steel die, and then was sintered at 1550° C. in air for 5 hours.

### Example 6

The ceria-based metal oxide, SDC, and the lanthanide metal oxide, SmAIO₃, obtained in the Preparation Example were mixed at a weight ratio of about 95:5. The mixed powder was then formed into a pellet shape having the dimensions 10 mm in diameter, and 5 mm in thickness using a stainless steel die, and then was sintered at 1550° C. in air for 5 hours.

### Evaluation Example 1

### Relative Density Measurements

FIG. 4 is a graph showing the results of relative density measurements on sintered hybrid phases that were obtained from Comparative Example 1, Examples 1 to 3, Comparative Example 2, and Examples 4 to 6.

As shown in FIG. 4, in the cases of Examples 1 to 6, in which the lanthanide metal oxides GdAIO₃ and SmAIO₃ were added, it may be seen that the relative densities are significantly increased by an addition of even a small amount of the lanthanide metal oxide (e.g., 1% weight).

### Evaluation Example 2

### Internal Microstructures of the Hybrid Layer

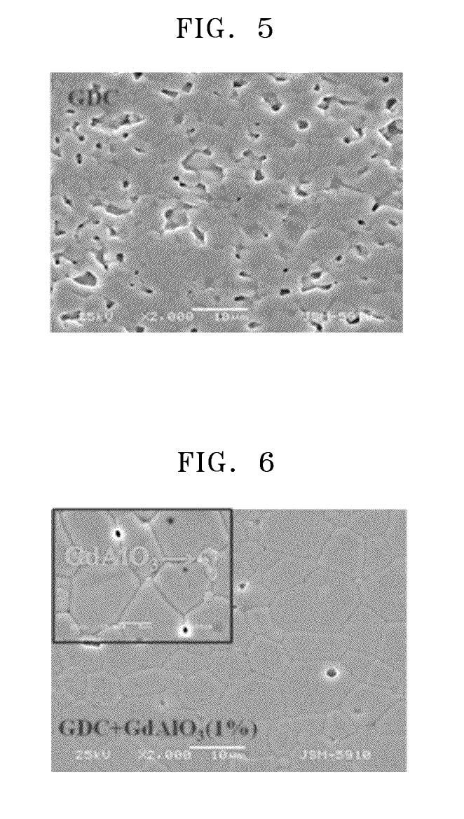

FIGS. 5 to 8 are scanning electron micrographs (“SEMs”) which show the internal microstructures of the sintered hybrid layers that were obtained from Comparative Example 1 and Examples 1 to 3.

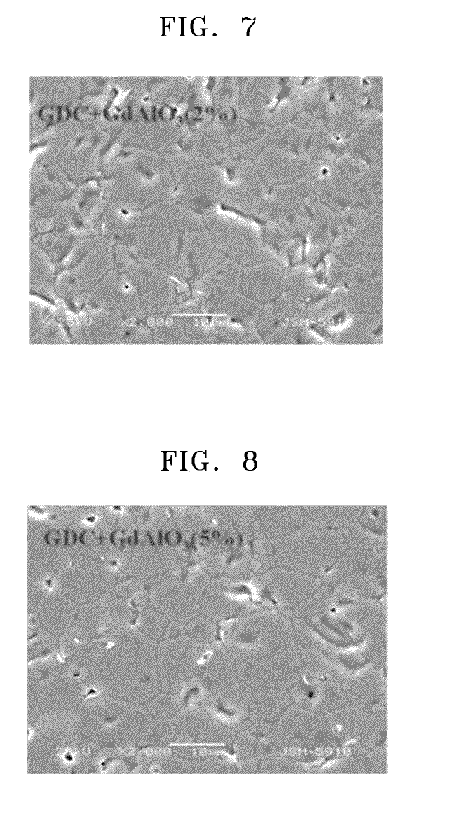

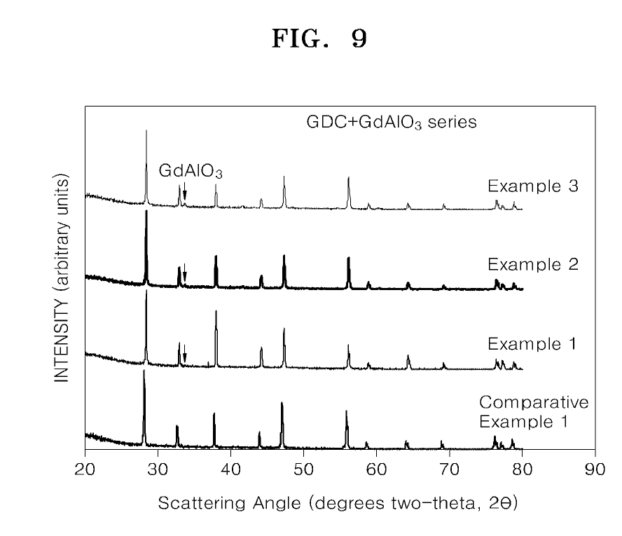

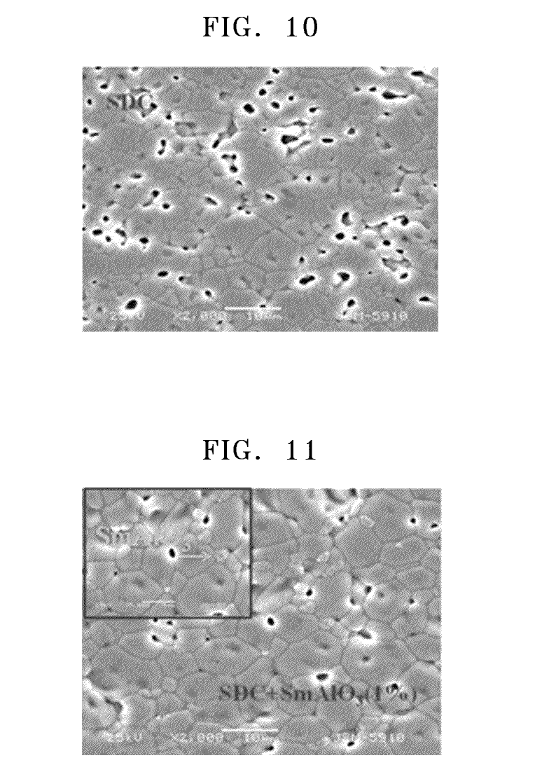

In the image of FIG. 5, which shows the microstructure of GDC, a hybrid phase to which no GdAIO₃ was added, many closed pores are found. However, in the images of FIGS. 6 to 8, which show the microstructures of hybrid phases derived from GDC and 1 wt % GdAIO₃, i.e., GDC to which a small amount of GdAIO₃ was added, the number of closed pores is significantly reduced, proving that the hybrid phases have high-density structures. The hybrid phase of FIG. 7 is derived from GDC with 2 wt % GdAIO₃, and the hybrid phase of FIG. 8 is derived from GDC with 5 wt % GdAIO₃. Secondary phases found in the SEM of FIGS. 6 to 8 represent GdAIO₃ having a perovskite structure. This is confirmed from the X-ray diffraction (“XRD”) results of FIG. 9. By analyzing the XRD results of the hybrids that were obtained from Examples 1 to 3, the formation of ceria phases and the secondary phases is confirmed.

### Evaluation Example 3

### Internal Microstructures of the Hybrids

FIGS. 10 to 14 are SEMs which show the internal microstructures of the sintered hybrid phases that were obtained from Comparative Example 2 and Examples 4 to 6.

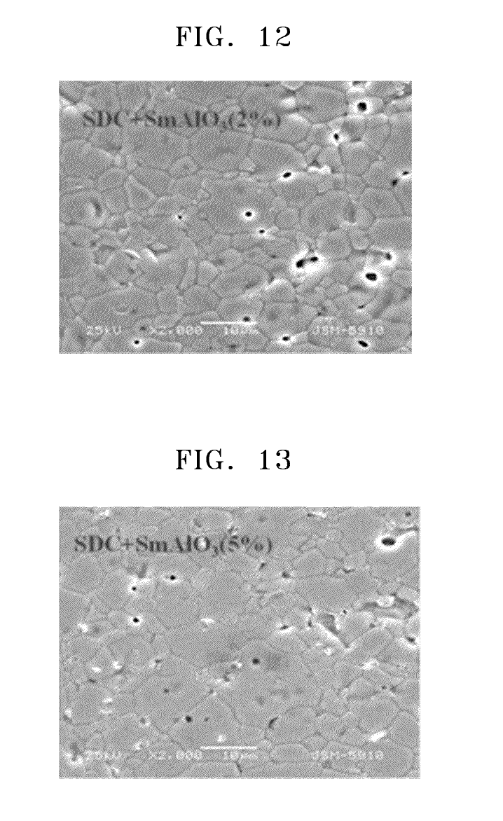

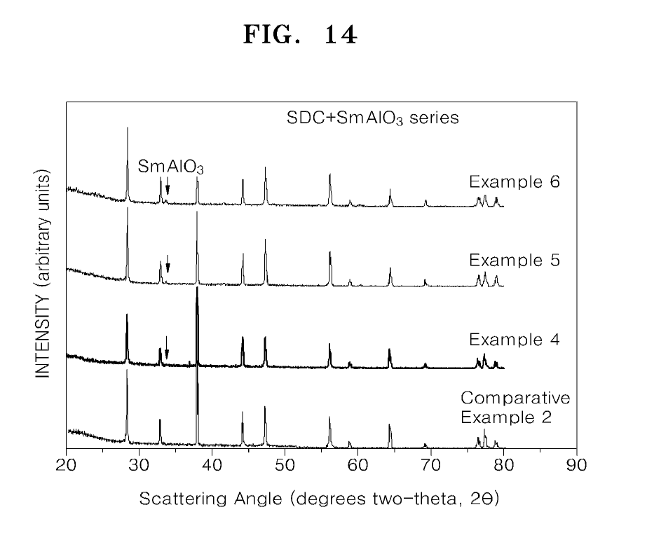

In the image of FIG. 10, which shows the microstructure of a hybrid layer of SDC to which no SmAlO₃ was added, many closed pores are found. However, in the images of FIGS. 11 to 13, which show the microstructure of hybrid layers to which a small amount of SmAlO₃ was added, the number closed pores is significantly reduced, proving that the hybrid layers have high-density structures. Shown in FIG. 11 is a hybrid layer derived from SDC with 1 wt % SmAlO₃, shown in FIG. 12 is a hybrid layer derived from SDC with 2 wt % SmAlO₃, and shown in FIG. 13 is a hybrid layer derived from SDC with 5 wt % SmAlO₃. Secondary phases found in the SEMS of FIGS. 11 to 13 include SmAlO₃, which has a perovskite structure. This is confirmed from XRD results of FIG. 14. By analyzing the XRD results of the hybrid layers that were obtained from Examples 4 to 6, the formation of ceria phases and the secondary phases is confirmed.

### Comparative Example 3

As an anode support, a hybrid material in which NiO and YSZ (8 mol %) are mixed was used. The hybrid material was manufactured into a cylindrical bulk monolith having the dimensions 30 mm in diameter and 150 mm in thickness using an injection molding method.

For a solid electrolyte, ScSZ (10 mol %) was used. In order to thinly coat the solid electrolyte on the anode supporter, a slurry for an electrolyte material that was obtained by adding 375 grams (g) of an organic vehicle (isopropyl alcohol (“IPA”)) to 19 g of the ScSZ was coated on the anode supporter, using a dip-coating method.

A coating layer was manufactured by obtaining a slurry for the coating layer from a mixture of 375 g of the organic vehicle (“IPA”) and 19 g of the ceria-based metal oxide, GDC that was obtained from Preparation Example, and coating the slurry on the solid electrolyte layer using the dip-coating method.

After the slurry coating, the coated slurry was heated at 1450° C. in air for 5 hours for densification.

### Example 7

### Manufacturing a Cylindrical Solid Oxide Fuel Cell

As an anode support, a hybrid material in which NiO and YSZ (8 mol %) are mixed was used. The hybrid material was manufactured into a cylindrical bulk monolith having the dimensions 30 mm in diameter and 150 mm in thickness using an injection molding method.

For a solid electrolyte, ScSZ (10 mol %) was used. In order to thinly coat the solid electrolyte on the anode support, a slurry for an electrolyte material that was obtained by adding 375 g of an organic vehicle (“IPA”) to 19 g of the ScSZ was coated on the anode support, using a dip-coating method.

A hybrid layer was manufactured by obtaining a slurry for the hybrid layer by mixing the ceria-based metal oxide, GDC, and the lanthanide metal oxide, GdAIO₃, which were obtained from Preparation Example, at a weight ratio of 99:1, into 19 g of mixed powder, and adding 375 g of the organic vehicle (“IPA”) thereto, and coating the slurry on the solid electrolyte layer using the dip-coating method.

After the slurry coating, the coated slurry was heated at 1450° C. in air for 5 hours for densification.

### Evaluation Example 4

### Relative Density Measurements

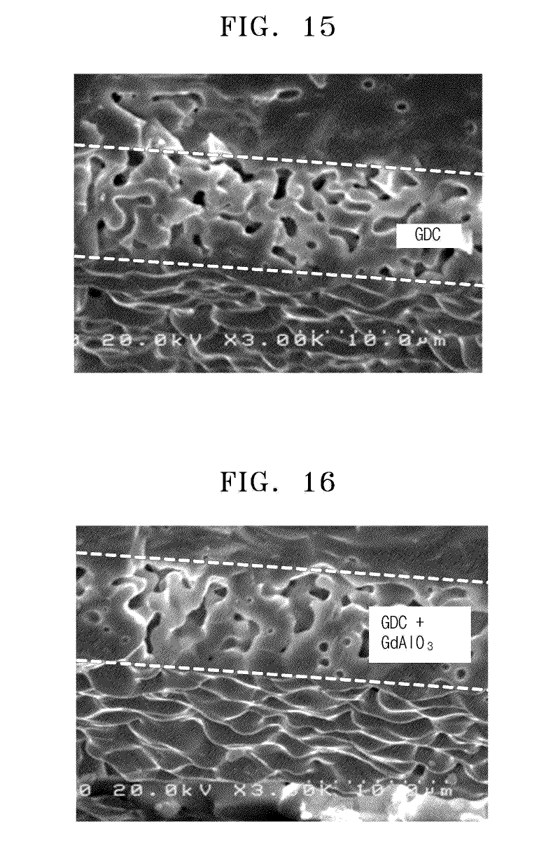

FIGS. 15 and 16 are SEMs which show the internal microstructures of the cylindrical solid oxide fuel cells that were obtained from Example 7 and Comparative Example 3, respectively.

It is observed by the naked eye that the hybrid layer of FIG. 16, which was derived from GDC and GdAIO₃, has a structure which is more elaborate than that of FIG. 15, which was derived from GDC. When relative densities of the coating layers were measured with an image analyzer, the coating layer of Comparative Example 1 has a relative density of 77%, while the hybrid layer of Example 7 has a relative density of 83%.

From these results, it was confirmed that the hybrid layer has a high density structure.

According to exemplary embodiments, solid electrolytes having the high density hybrid layer of the ceria-based material and the lanthanide metal oxide formed on one side of the solid electrolyte are disclosed. Also disclosed are solid oxide fuel cells having the solid electrolyte. The foregoing are understood to suppress undesirable diffusion and/or reaction of a composition of the cathode layer with the electrolyte, and thus maintain a low resistance at a temperature of 800° C. or less.

It should be understood that the exemplary embodiments disclosed herein should be considered in a descriptive sense only and not for purposes of limitation. Descriptions of features, advantages, or aspects within each embodiment shall be considered as available for other similar features, advantages, or aspects of other embodiments.

What is claimed is:

1. A solid electrolyte for a solid oxide fuel cell, the solid electrolyte comprising:
a zirconia layer; and
a hybrid layer comprising a hybrid phase according to Formula 1:
(1−y)(Ce₁₋ₓL′O₂)+y(L″MO₃) Formula 1
wherein the hybrid layer is disposed on at least one surface of the zirconia layer, and
wherein, L′ and L″ are each independently at least one element selected from the lanthanide group,
M is at least one element selected from aluminum, gallium, Indium, and scandium,
x is about 0.0001 to about 0.3, and
y is about 0.0003 to about 0.05.

2. The solid electrolyte of claim 1, wherein a relative density of the hybrid layer is about 80%.

3. The solid electrolyte of claim 1, wherein a relative density of the hybrid layer is about 80% to about 98%.

4. The solid electrolyte of claim 1, wherein the hybrid layer has a density effective to prevent a reaction of a cathode material.

5. The solid electrolyte of claim 1, wherein the at least one element selected from the lanthanide group is at least one element selected from gadolinium and samarium.

6. The solid electrolyte of claim 1, wherein M comprises aluminum.

7. The solid electrolyte of claim 1, wherein the zirconia layer comprises at least one selected from yttria-stabilized zirconia and scandia-stabilized zirconia.

8. The solid electrolyte of claim 1, wherein the hybrid layer has a thickness of about 1 micrometer to about 30 micrometers.

9. A hybrid phase according to Formula 1:
(1−y)(Ce₁₋ₓL′O₂)+y(L″MO₃) Formula 1
wherein L′ and L″ are each independently at least one element selected from the lanthanide group,
M is at least one element selected from aluminum, gallium, Indium, and scandium,
x is about 0.0001 to about 0.3, and
y is about 0.0003 to about 0.05.

10. A solid oxide fuel cell comprising:
a cathode;
an anode; and
the solid electrolyte according to claim 1 interposed between the cathode and the anode.

11. The solid oxide fuel cell of claim 10, further comprising a second hybrid layer interposed between the solid electrolyte and the cathode.
